(19) United States
(12) Patent Application Publication
(10) Pub. No.: US 2014/0040344 A1
(43) Pub. Date: Feb. 6, 2014

(54) NOTIFICATIONS AND REQUESTS IN A NETWORK APPLICATION

(71) Applicants: Florian Gehring, Ubstadt-Weiher (DE); Sabine Finke, Karlsruhe (DE); Christian Ortmann, Karlsdorf-Neuthard (DE); Christian Kirschnick, Heidelberg (DE); Gerald Reinhard, Schwetzingen (DE)

(72) Inventors: Florian Gehring, Ubstadt-Weiher (DE); Sabine Finke, Karlsruhe (DE); Christian Ortmann, Karlsdorf-Neuthard (DE); Christian Kirschnick, Heidelberg (DE); Gerald Reinhard, Schwetzingen (DE)

(73) Assignee: SAP AG, Walldorf (DE)

(21) Appl. No.: 13/563,424

(22) Filed: Jul. 31, 2012

(51) Int. Cl. G06F 15/16

(52) U.S. Cl. 709/203

(57) ABSTRACT

Users of network-based collaborative applications can be notified in real-time based on workflow changes or notifications. In one embodiment, a persistent icon can be displayed that is visible from different pages in the application. The persistent icon can be visible from any page in the application on an application toolbar. When a notification or workflow request is posted, the persistent icon can be dynamically updated in real time, and without the need for refreshing the currently displayed view. Additionally, notification and workflow requests can be sent to multiple users simultaneously. When a notification or request is received, a counter can be incremented indicating a number of unread notifications or requests.

### BACKGROUND

Cloud computing refers to the delivery of computing and storage capacity as a service to a heterogeneous community of end-recipients. In typical cloud-based environments, using Infrastructure as a Service, users rent the use of servers provided by one or more cloud providers. The cloud providers manage the infrastructure and platforms on which the applications run.

End users access cloud-based applications through a web browser or a light-weight desktop or mobile app while the business software and user's data are stored on servers at a remote location. Cloud computing allows enterprises to get their applications up and running faster, with improved manageability and less maintenance, and enables IT to more rapidly adjust resources to meet fluctuating and unpredictable business demand.

Cloud computing relies on sharing of resources to achieve coherence and economies of scale similar to a utility over a network, such as the Internet. At the foundation of cloud computing is the broader concept of converged infrastructure and shared services.

An example shared service is a human resource application wherein users can collaboratively work together on activities.

### SUMMARY

Users of network-based collaborative applications can be notified in real-time based on workflow changes or notifications.

In one embodiment, a persistent icon can be displayed that is visible from different pages in the application. In one particular example, the persistent icon remains visible from any page in the application on an application toolbar. When a notification or workflow request is posted, the persistent icon can be dynamically updated in real time, and without the need for refreshing the currently displayed view. Additionally, notification and workflow requests can be sent to multiple users simultaneously. When a notification or request is received, a counter can be incremented indicating a number of unread notifications or requests.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The foregoing and other objects, features, and advantages of the invention will become more apparent from the following detailed description, which proceeds with reference to the accompanying figures.

### BRIEF DESCRIPTION OF THE DRAWINGS

FIG. 1 is a system diagram showing multiple client computers accessing a network application simultaneously.

FIG. 2 is an exemplary user interface showing one or more persistent icons for accessing notifications or requests from other users.

FIG. 3 is an exemplary user interface showing a counter associated with the persistent icon.

FIG. 4 is an exemplary user interface wherein a user accesses a list of notifications using the persistent icon.

FIG. 5 is an exemplary user interface wherein a user is generating a request to another user.

FIG. 6 is an exemplary user interface wherein a user receives a request that is indicated in a counter associated with the persistent icon.

FIG. 7 is an exemplary user interface wherein a user can use the persistent icon to access a list of current requests.

FIG. 8 is an exemplary user interface indicating that the user agreed to a request.

FIG. 9 is an embodiment of a flowchart that can be used to post a request or notification in a persistent icon.

FIG. 10 is an embodiment of a flowchart that can be used to access notifications or requests.

FIG. 11 is an exemplary server computer that can be used for executing the network application.

### DETAILED DESCRIPTION

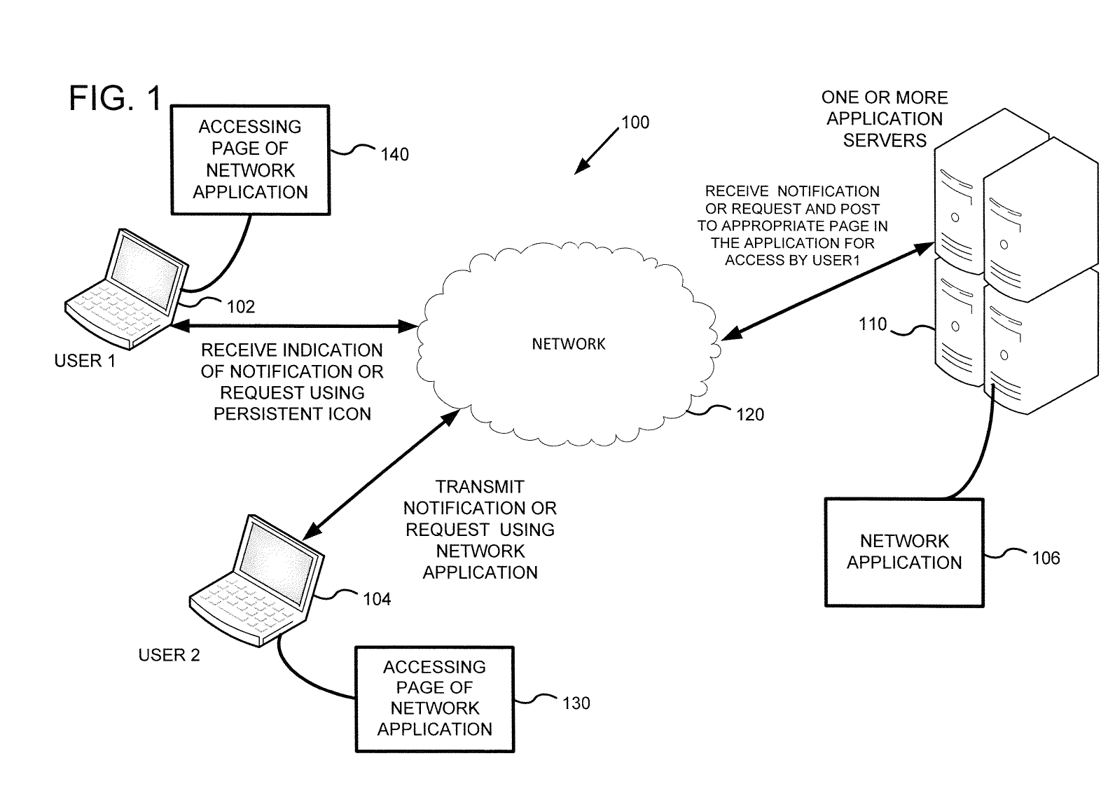

FIG. 1 is a system diagram 100 showing multiple client devices 102, 104 (which are shown as computers but can be tablets, phones, notebooks, etc.) accessing a shared network application 106 executing on one or more server computers 110. Typically, the client computers 102, 104 use a browser to access the network application 106, but other client-side applications can be used. The browser uses a network address of the one or more server computers 110 and accesses the network application 106 via a network 120, such as the Internet. Although only two client computers are shown, any number of client computers can access the application 106 simultaneously. For example, the network application 106 can be a human resource application that allows multiple users to work collaboratively on activities and goals. Generally, each user has his/her own application pages accessible and personalized so that they can view their own goals and activities. FIG. 1 shows a user2 accessing a page 130 of the network application and transmitting a notification or request. A notification can be information (e.g., a message) that does not require acceptance or rejection, whereas a request can require a response to accept or reject an identified goal or activity. Generally, notifications and requests do not contain an email address of another user. Rather, upon receiving the notification or request, the one or more server computers 110 can determine which pages of the application to update so as to make the notification or request available to other users. If a notification or request is public, it may go to all users. Alternatively, the notification or request can be transmitted to a subset of users, such as a predefined group. Once the recipients are identified, the server computers 110 can push the notification or request to application pages of members of the group. User1 can receive a real-time indication that a request or notification has been posted for viewing. By real-time it is meant that the notification or request is processed with minimal delay and can be received within seconds of transmission. The real-time indication can be displayed in a persistent icon displayed on a page 140 being accessed by user1. As described further below, the indication can take a variety of forms to indicate a notification or request are pending and are viewable. In one example, the persistent icon can change color, blink or change form. Alternatively, a counter can be associated with the icon to show a number of pending notifications or requests. As described further below, the persistent icon can be a visible UI element that remains displayed regardless of which page of the application the user accesses. In this way, the user can have substantially immediate knowledge that a new notification or request has been received wherever the user might be in the application. Furthermore, the persistent icon can be automatically refreshed without further user interaction.

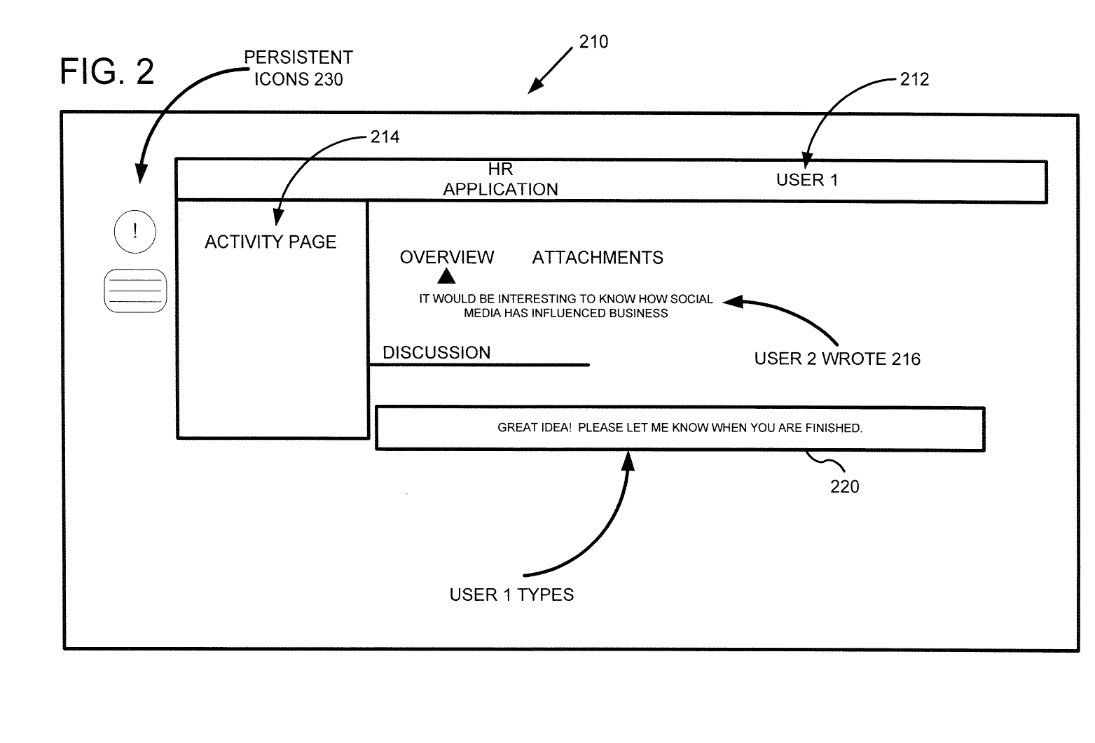

FIGS. 2-4 show a series of application pages that can be used in regard to notifications sent between users of the network application. The particular design of the user interface can easily be modified without changing the underlying technology described herein. FIG. 2 shows an example user interface page 210 that can be accessed via a browser or other application, as described above. The particular application is a collaborative Human Resource application that allows users to work together simultaneously on activities. As indicated at 212, the user (i.e., User1, which is typically a proper user name) accesses his/her personal page. The particular page shown is an activity page, as indicated at 214. At 216, User1 can review a description of an activity by User2. User1 can then access a comment box shown at 220 and type in a comment to the activity. Upon hitting enter, the user input notification can be sent from the client device and received by the one or more server computers on which the network application is being executed. The server computers can determine which recipients are to receive the notification and post the notification on the appropriate page or pages, as further described below. At 230, there are one or more persistent icons that can be displayed regardless of which page in the application the user is accessing. The persistent icons 230 can be located in a tool bar or simply positioned at a predetermined and consistent location. As further described below, the persistent icons are user interface elements that can change to indicate receipt of a notification or request.

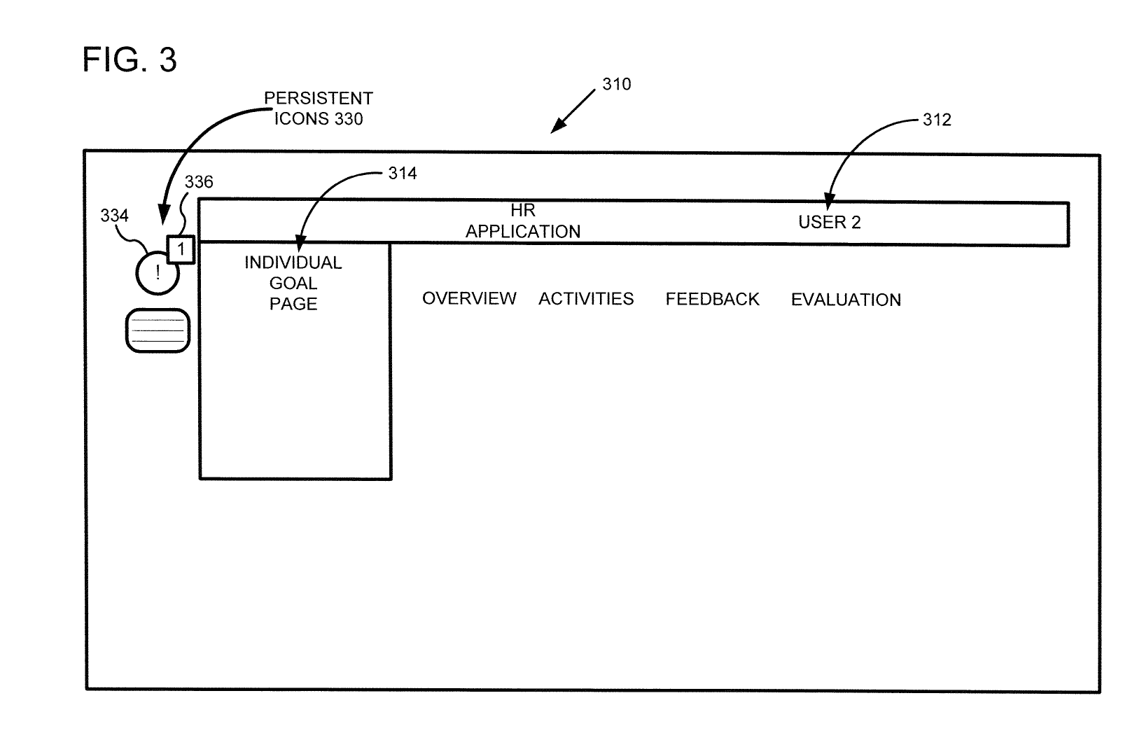

FIG. 3 shows a user interface page 310 for User2, as indicated at 312. User2 is currently viewing an individual goal page, as indicated at 314. In response to User1 sending the notification, as described above in relation to FIG. 2, User2 receives a substantially immediate indication (except for a latency period) in real-time and without needing to refresh the display using one of the persistent icons 330. In particular, a notification icon 334 can have an associated counter 336 that is incremented to show a number of unread notifications. The counter can be integrated into the persistent icon or spaced therefrom. If an additional notification is received, the counter can be further incremented. Other indications of receiving a notification can be used instead (e.g., color change, change of shape, etc.)

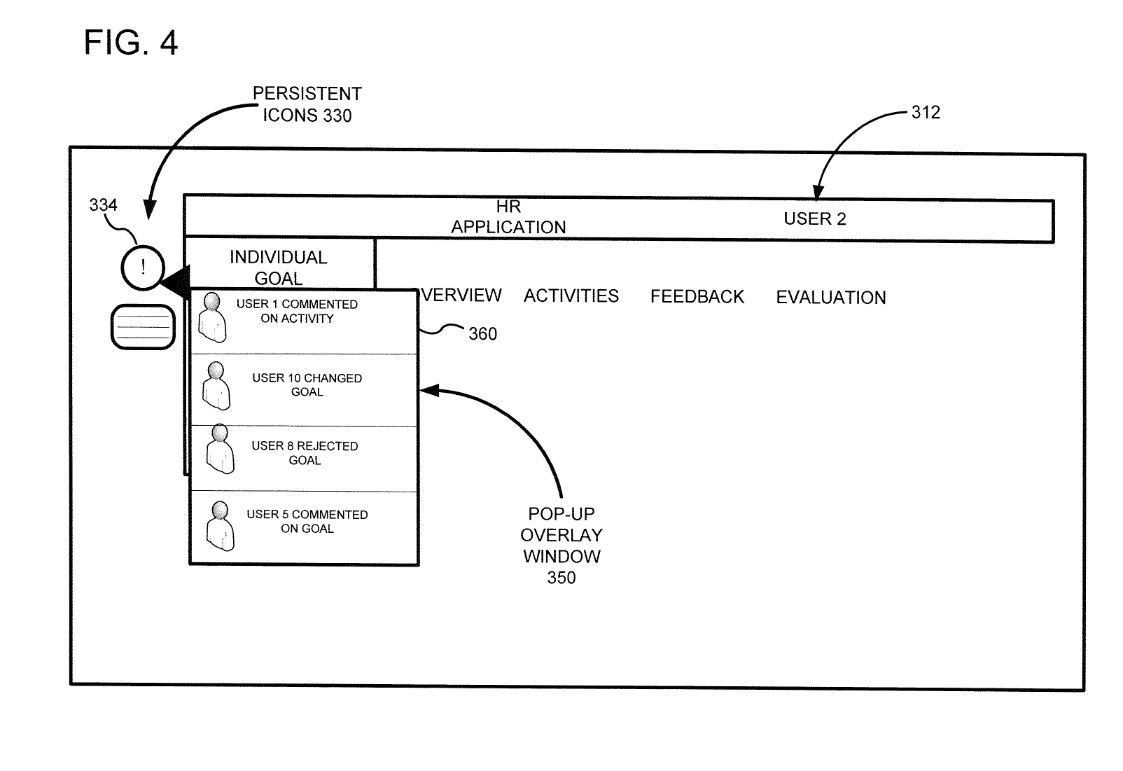

FIG. 4 shows that if the user selects (e.g., clicks on) the icon 334 or counter 336 (FIG. 3), then a pop-up window 350 can be displayed listing latest notifications that have been received. The notification triggered by comment 220 from User1 (FIG. 2) can be seen at 360 as being received by User2. User2 can click on notification 360 to see the full text of the notification, as is well understood in the art. The counter 336 of FIG. 3 has been decremented to zero and cleared (e.g., removed) in response to clicking on the icon 334 or counter 336 so that the persistent icon 334 returns to its previous state. Selection of the persistent icon again or clicking anywhere else on the screen but the window 350 can close the window 350.

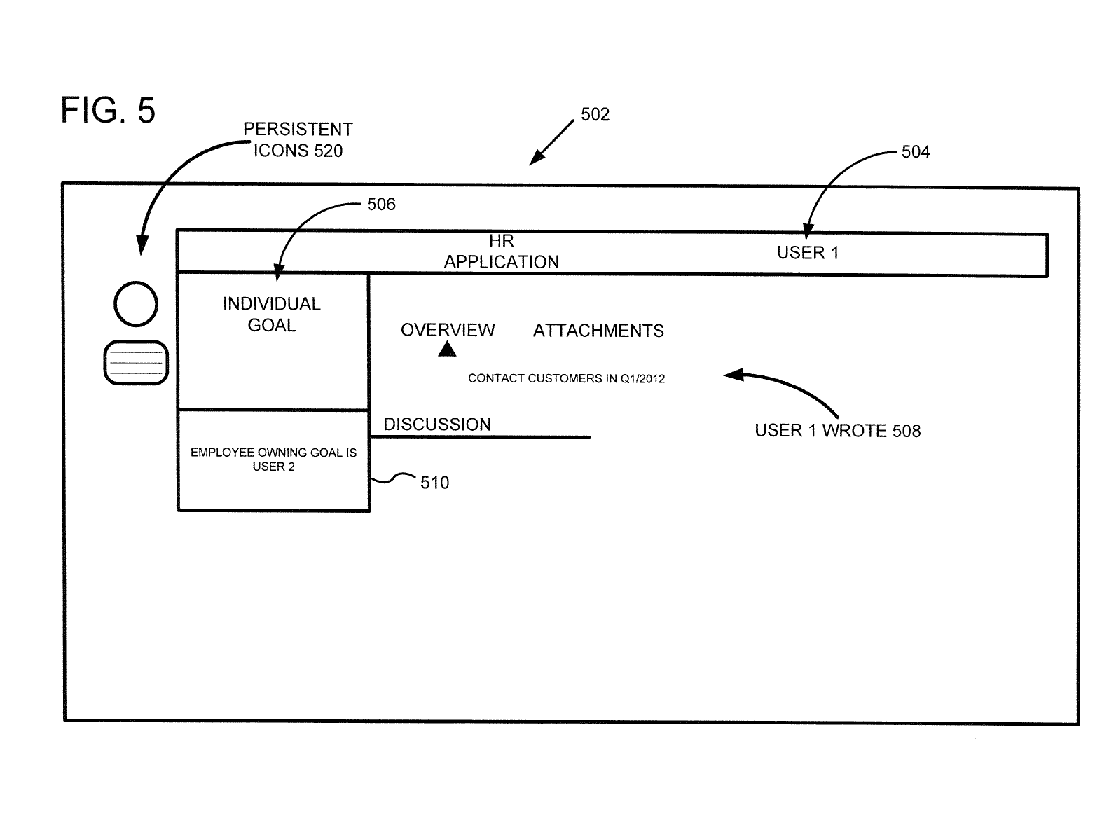

FIGS. 5-8 show a series of user interface pages that can be displayed in regards to requests made between users of the network application. FIG. 5 shows a user interface page 502 with User1 504 on an individual goal page 506. User1 wrote a request at 508 and selected User2 as owning the goal at 510. As shown at 520, persistent icons are displayed regardless of a page being displayed. User1 can then hit return to send the request 508.

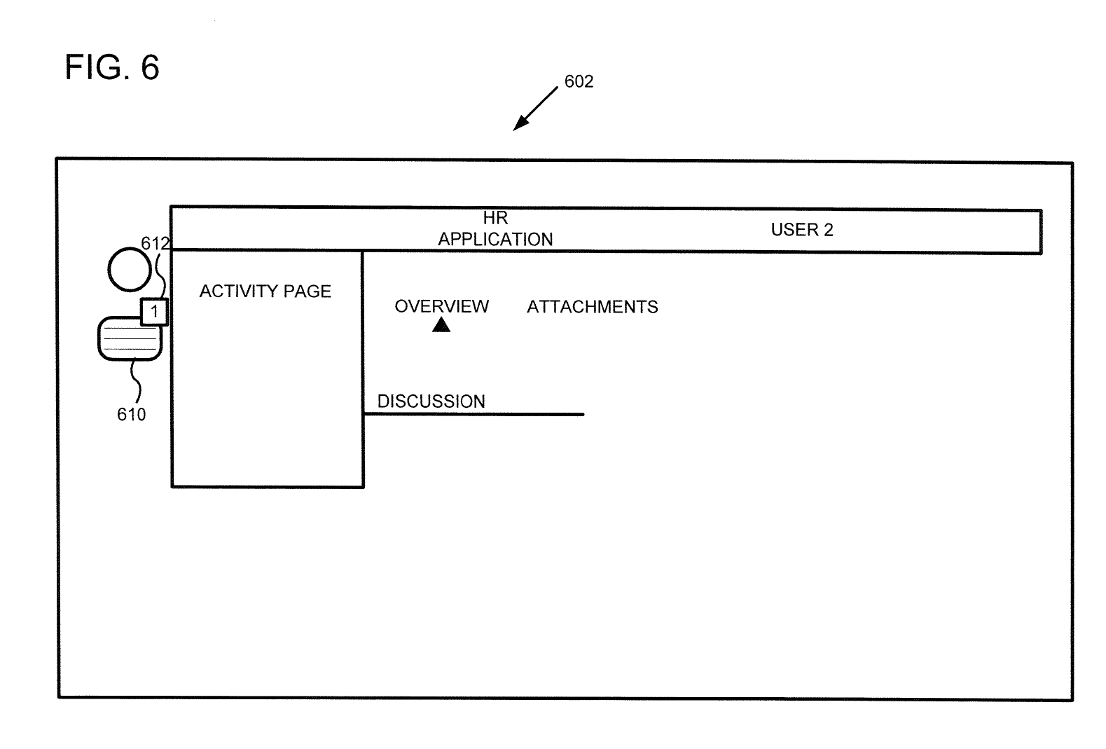

FIG. 6 shows a response of the sent request 508 at a user interface page 602 of User2. In persistent icon 610, a counter indication 612 is displayed in association with the icon 610 to indicate that a request is pending. Thus, a real-time and substantially immediate change is made to page 602, which is automatically refreshed on a client computer being used by User2. The counter indication indicates a request has been received and not yet viewed. As previously described, the counter can be replaced by other indicators, such a change in color, size, shape, etc.

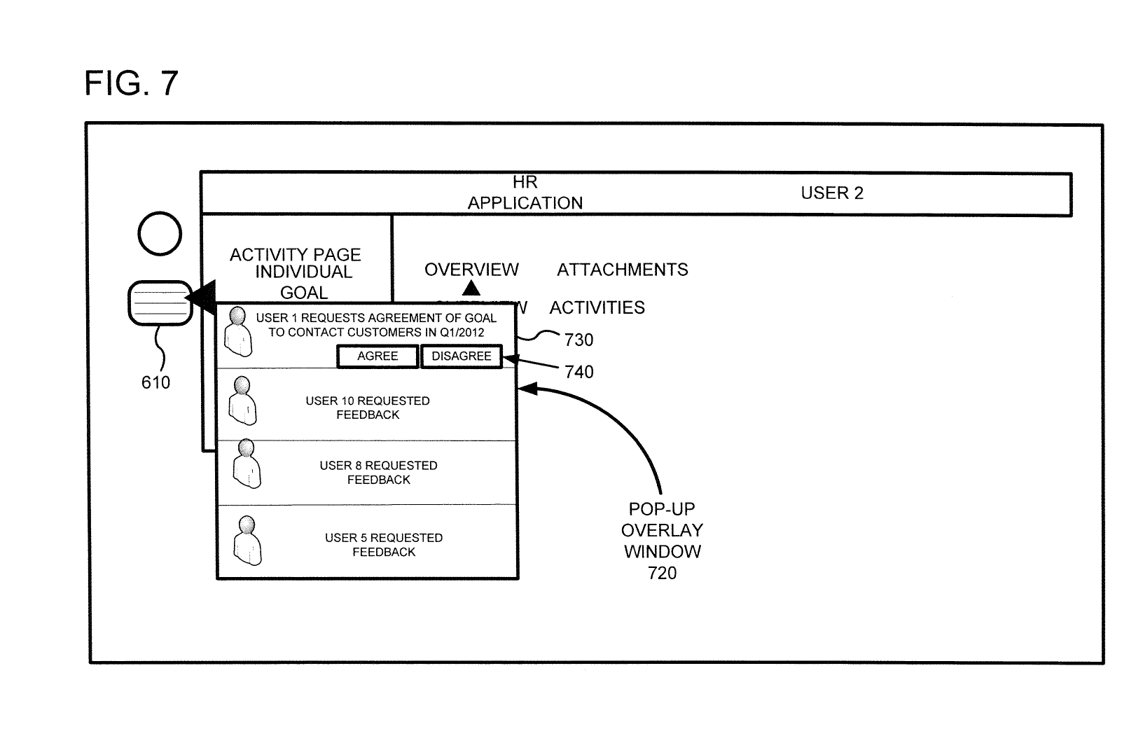

FIG. 7 shows that when User2 selects icon 610, a pop-up overlay window 720 is displayed that includes a list of the latest requests. Request 730 corresponds to the request 508 (FIG. 5) written by User1. The request 730 requires User2 to agree or disagree (i.e., accept or reject) the request, as shown at 740. Once User2 opens the window 720, the counter indication 612 is removed.

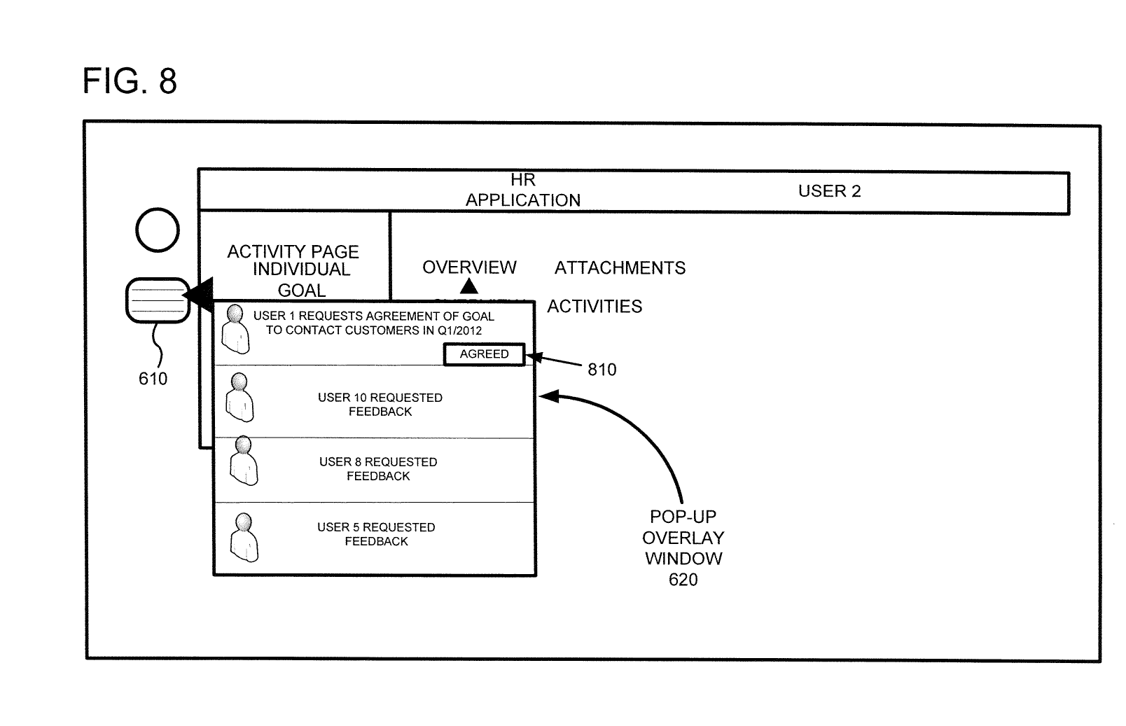

FIG. 8 shows that User2 accepted the request as indicated at 810. After the user selects the “Agreed” button, the result is sent back to the server and User1 is updated on the response. Additionally, once the request is accepted, the server can modify User2's pending list of activities and/or goals. The persistent icon 610 can be clicked again to remove the overlay window 620. Indeed, clicking anywhere but the overlay window 620 can close the overlay window.

In an alternative embodiment, the agree and disagree buttons can be positioned outside of the window 620, such as on the individual goal page. Other locations can also be used.

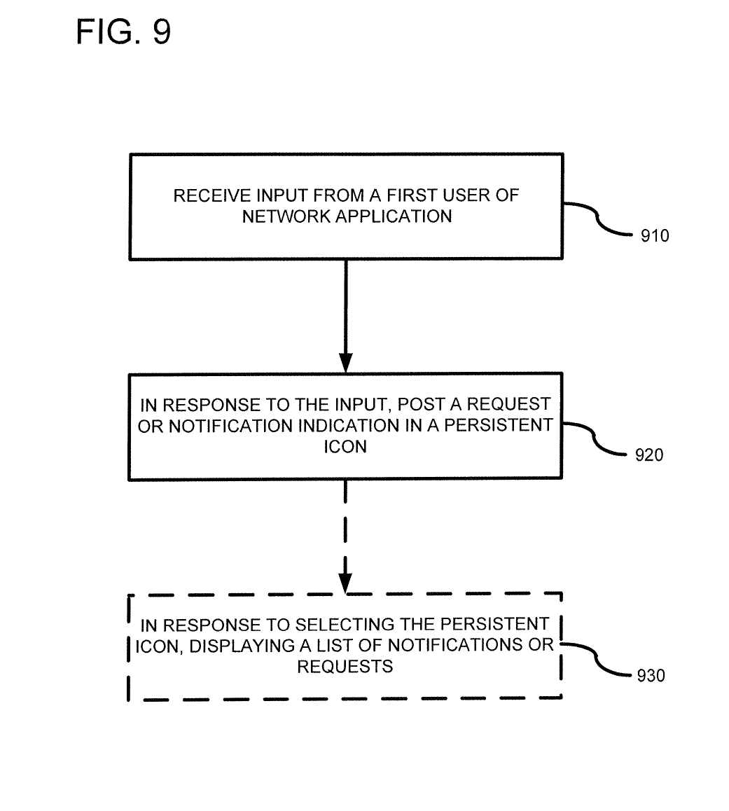

FIG. 9 shows a flowchart of a method for posting a notification or request indication to a user of the network application. In process block 910, user input is received from a first user of the network application. The input can be a notification (e.g., message) or a request, for which a response is desired. In process block 920, in response to the user input, the network application posts a request or notification indication in a persistent icon. The indication can be a counter, for example. The request and notification icons in any of the embodiments described herein can be separate icons or a single icon, which when selected shows either the latest request or notification or a combination of the two. The persistent icon is displayed across different pages in the network application and can be shown on every page at a predetermined location, regardless of which page the user is accessing. Additionally, the request or notification indication can be automatically refreshed without user interaction. An additional process block 930 can be added, as shown in dashed lines, in which in response to selection of the persistent icon, displaying a list of notifications or requests. The list can be a combination of read and unread notifications or requests.

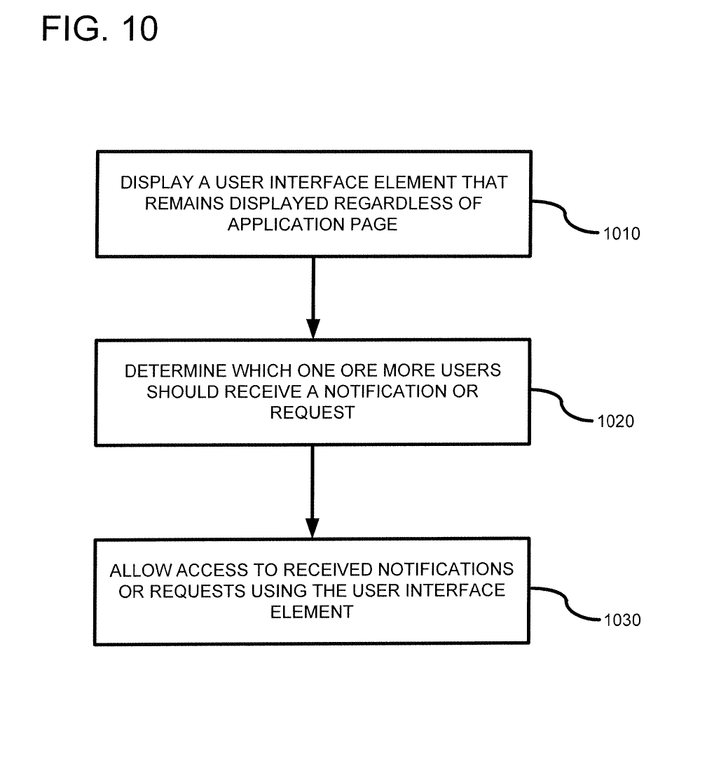

FIG. 10 shows a flowchart of a method for posting a notification or request indication. In process block 1010, a user interface element is displayed and remains displayed regardless of the application page. Thus, a user can browse between different pages and the user interface element remains visible on every page. In process block 1020, a determination is made which users should receive the notification or request. Generally, in such workflow applications, email addresses are not needed. Instead, the server computer can determine which users should get the notification or request based on relationships between the users (e.g., same team). In process block 1030, the application can allow access to received notifications or requests using the user interface element. If the recipient is not online at the time of the notification or request, an additional email can be sent to the user.

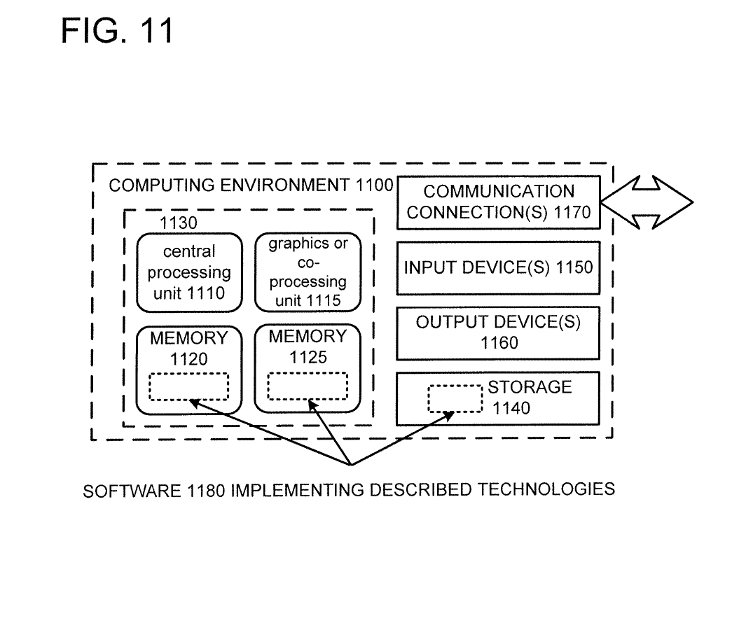

FIG. 11 depicts a generalized example of a suitable computing environment 1100 in which the described innovations may be implemented. The computing environment 1100 is not intended to suggest any limitation as to scope of use or functionality, as the innovations may be implemented in diverse general-purpose or special-purpose computing systems. For example, the computing environment 1100 can be any of a variety of computing devices (e.g., desktop computer, laptop computer, server computer, tablet computer, media player, gaming system, mobile device, etc.).

With reference to FIG. 11, the computing environment 1100 includes one or more processing units 1110, 1115 and memory 1120, 1125. In FIG. 11, this basic configuration 1130 is included within a dashed line. The processing units 1110, 1115 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 11 shows a central processing unit 1110 as well as a graphics processing unit or co-processing unit 1115. The tangible memory 1120, 1125 may be volatile memory (e.g., registers, cache, RAM), non-volatile memory (e.g., ROM, EEPROM, flash memory, etc.), or some combination of the two, accessible by the processing unit(s). The memory 1120, 1125 stores software 1180 implementing one or more innovations described herein, in the form of computer-executable instructions suitable for execution by the processing unit(s). The software can be the network application described herein.

A computing system may have additional features. For example, the computing environment 1100 includes storage 1140, one or more input devices 1150, one or more output devices 1160, and one or more communication connections 1170. An interconnection mechanism (not shown) such as a bus, controller, or network interconnects the components of the computing environment 1100. Typically, operating system software (not shown) provides an operating environment for other software executing in the computing environment 1100, and coordinates activities of the components of the computing environment 1100.

The tangible storage 1140 may be removable or non-removable, and includes magnetic disks, magnetic tapes or cassettes, CD-ROMs, DVDs, or any other medium which can be used to store information in a non-transitory way and which can be accessed within the computing environment 1100. The storage 1140 stores instructions for the software 1180 implementing one or more innovations described herein.

The input device(s) 1150 may be a touch input device such as a keyboard, mouse, pen, or trackball, a voice input device, a scanning device, or another device that provides input to the computing environment 1100. For video encoding, the input device(s) 1150 may be a camera, video card, TV tuner card, or similar device that accepts video input in analog or digital form, or a CD-ROM or CD-RW that reads video samples into the computing environment 1100. The output device(s) 1160 may be a display, printer, speaker, CD-writer, or another device that provides output from the computing environment 1100.

The communication connection(s) 1170 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., non-transitory computer-readable media, such as one or more optical media discs, volatile memory components (such as DRAM or SRAM), or nonvolatile memory components (such as flash memory or hard drives)) and executed on a computer (e.g., any commercially available computer, including smart phones or other mobile devices that include computing hardware). As should be readily understood, the term computer-readable storage media does not include communication connections, such as modulated data signals. Any of the computer-executable instructions for implementing the disclosed techniques as well as any data created and used during implementation of the disclosed embodiments can be stored on one or more computer-readable media (e.g., non-transitory computer-readable media, which excludes propagated signals). The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Peri, JavaScript, Adobe Flash, or any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope of these claims.

We claim:

1. A method of notifying or requesting, the method comprising:
receiving input from a first user of a network application; and
in response to the input from the first user, posting a request or notification indication in a persistent icon to a second user of the network application, wherein the network application is executed on one or more server computers and is accessible by both the first and second users;
wherein the persistent icon is for being displayed across different pages in the network application.

2. The method of claim 1, wherein the request or notification indication is a counter associated with the persistent icon which displays a number of pending notifications or requests.

3. The method of claim 1, wherein the input from the first user does not include an email address, and further including determining which one or more users of the network application should receive the notification or request.

4. The method of claim 1, further including receiving user input selecting the persistent icon and displaying a pop-up window listing a plurality of notifications or requests.

5. The method of claim 1, wherein the input from the first user is a request and further including displaying acceptance and rejection buttons.

6. The method of claim 5, further including automatically sending a response to the first user whether the request is accepted or rejected.

7. The method of claim 1, wherein the persistent icon is automatically refreshed.

8. The method of claim 2, further including decrementing or clearing the counter when a user reads the notification or request.

9. The method of claim 1, wherein the browser-based network application is a collaborative human resources application which allows users to work together simultaneously on activities and goals.

10. One or more computer-readable storage having instructions thereon for executing a method, the method comprising:
displaying a user interface element in a browser-based application that remains displayed regardless of which page in the application is being accessed; and
allowing access to received notifications or requests from other users of the browser-based application using the user interface element.

11. The computer-readable storage of claim 10, wherein the user interface element is persistently displayed in the browser-based application that is being accessed.

12. The computer-readable storage of claim 10, further including associating a counter with the user interface element, the counter being incremented whenever a notification or request is received and decremented when read.

13. The computer-readable storage of claim 10, wherein the received requests are workflow items that can be accepted or rejected by a recipient of the notification.

14. The computer-readable storage of claim 10, further including displaying a pop-up window in response to selection of the user interface element, the pop-up window including a list of pending notifications or requests.

15. The computer-readable storage of claim 10, wherein the browser-based application is a collaborative human resource application accessible to multiple client computers simultaneously so that users can work together on activities and goals.

16. A system including an application for notifying users, comprising:
a server computer executing an application accessible by multiple client computers simultaneously, the application allowing multiple users to work collaboratively on activities;
the application for displaying a persistent icon regardless of a page of the application that a user is accessing; and
the persistent icon being selectable for displaying additional information being communicated between users of the application.

17. The system of claim 16, wherein the application is accessible through a browser interface, each user has personalized workflow pages associated with activities and goals, and the persistent icon has a counter associated therewith that is personalized for each user.

18. The system of claim 16, wherein the additional information is a notification of a message being passed between users of the application.

19. The system of claim 16, wherein the additional information is a workflow request in which a user either accepts or rejects.

20. The system of claim 16, wherein selection of the persistent icon results in a pop-up window being displayed with a list of notifications or workflow requests.
